(19) United States
(12) Patent Application Publication
(10) Pub. No.: US 2025/0296830 A1
(43) Pub. Date: Sep. 25, 2025

(54) TRAINING AID FOR A HORSE

(71) Applicant: Sarah Kearvell, Koo Wee Rup (AU)

(72) Inventor: Sarah Kearvell, Koo Wee Rup (AU)

(21) Appl. No.: 18/615,643

(22) Filed: Mar. 25, 2024

(51) Int. Cl. B68B 1/04; B68C 1/14

(52) U.S. Cl. CPC B68B 1/04; B68C 1/147

(57) ABSTRACT

A training aid for training a horse to adapt to using a bridle includes a saddle pad and a girth or similar support. A rein assembly attaches to and extends between lateral portions of the saddle pad. The rein assembly is made to be threaded through a pair of bit rings and to be readily slidable through the bit rings when attached to the saddle pad. A tie down strap slidably attaches to the rein assembly and affixes to the girth. The tie down strap is elastic so that the tie down ring does not overly restrict movement of the horses head upwardly or forwardly, and a likelihood of causing the horse to panic is lessened.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to training aids and more particularly pertains to a new training aid for training a horse to adapt to using a bridle.

### (2) Description of Related Art Including Information Disclosed Under 37 CFR 1.97 and 1.98

The prior art relates to training aids used to train a horse to respond to movements of a bridle. The prior art discloses myriad harnesses for training horses, but fails to disclose such a harness that slidably attaches a bit worn by the horse to a rein assembly that extends between opposite lateral sides of a saddle pad and attaches an elastic tie down strap between the rein assembly and a girth. Such an apparatus is advantageous in allowing the horse to move its head upwardly and forwardly without panicking due to a more constrictive tie down strap and allowing free movement of the head side to side.

### BRIEF SUMMARY OF THE INVENTION

An embodiment of the disclosure meets the needs presented above by generally comprising a support assembly configured to wrap around a back and a belly of a horse. The support assembly comprises an upper member configured to lie on the back of the horse and a lower member configured to lie over the belly of the horse. A rein assembly is attached to and extends between a first lateral portion of the upper member and a second lateral portion of the upper member. The rein assembly is configured to be received through each one of a pair of bit rings and to be freely slidable with respect to each bit ring. A tie down strap is removably coupled to the rein assembly and the support assembly. A first end of the tie down strap is slidably coupled to the rein assembly and configured to be positioned between the pair of bit rings along the rein assembly. A second end of the tie down strap is coupled to the lower member of the support assembly. The tie down strap is configured to extend from the rein assembly between a pair of front legs of the horse to the belly during normal use and includes a resiliently stretchable material which allows the horse to stretch the tie down strap without causing discomfort or panic in the horse.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of a training aid according to an embodiment of the disclosure.

FIG. 2 is a kit view of an embodiment of the disclosure.

FIG. 3 is a first side in-use view of an embodiment of the disclosure.

FIG. 4 is a second side in-use view of an embodiment of the disclosure.

FIG. 5 is a detail view of an embodiment of the disclosure taken from Window 5 in FIG. 3.

FIG. 6 is a detail view of an embodiment of the disclosure taken from Window 6 in FIG. 3.

### DETAILED DESCRIPTION OF THE INVENTION

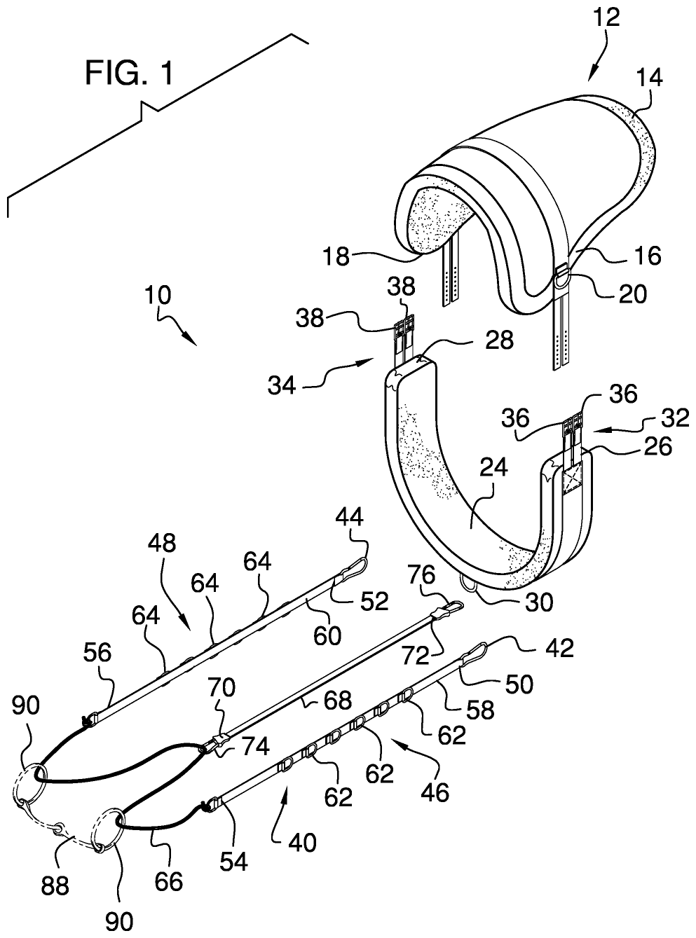

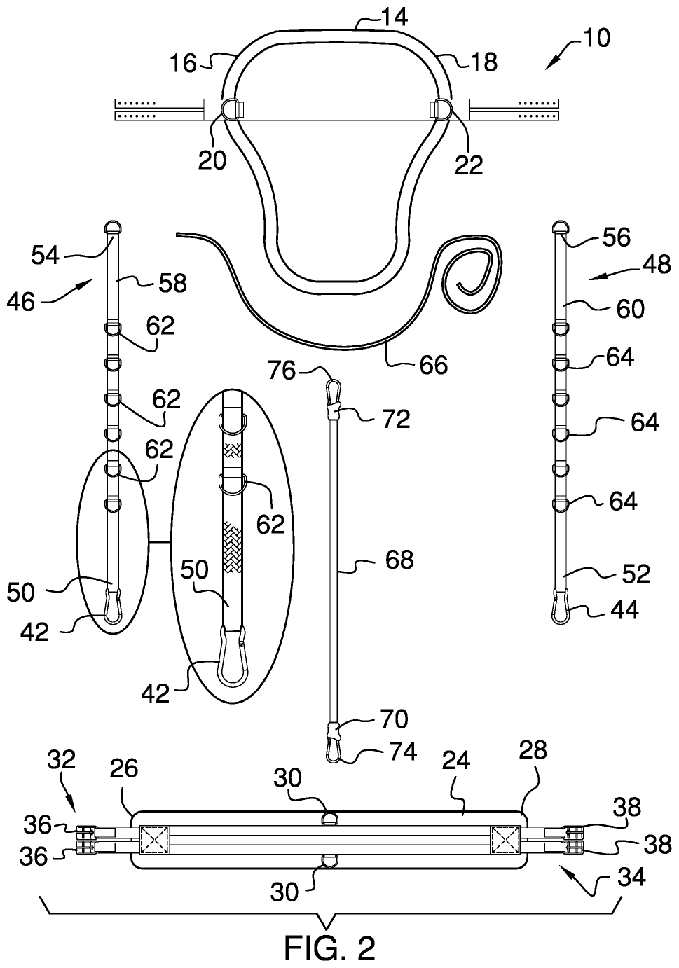

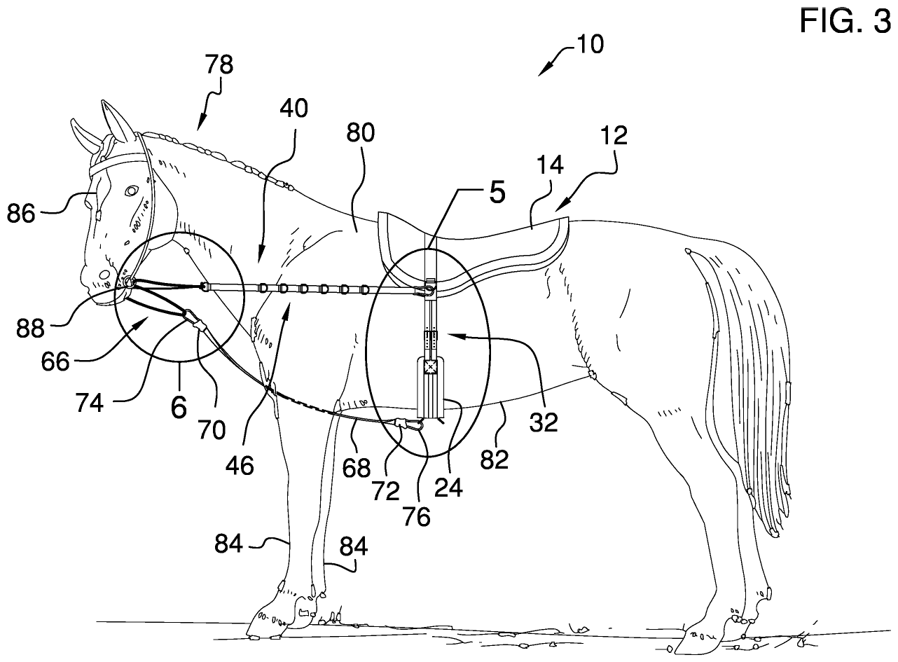

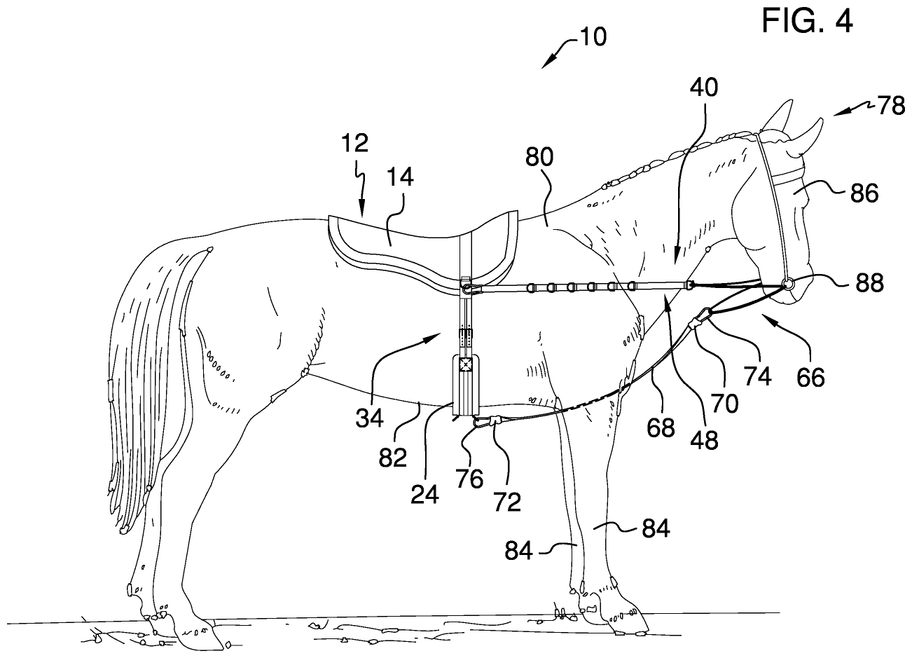

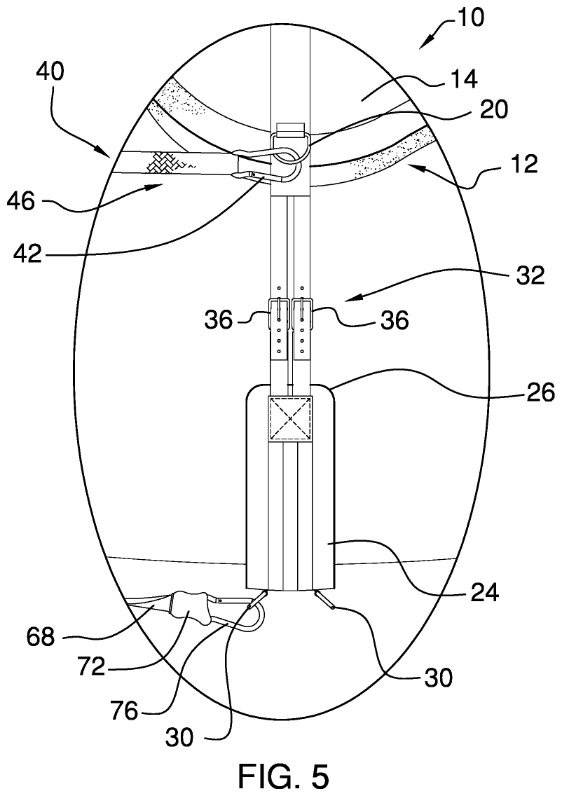

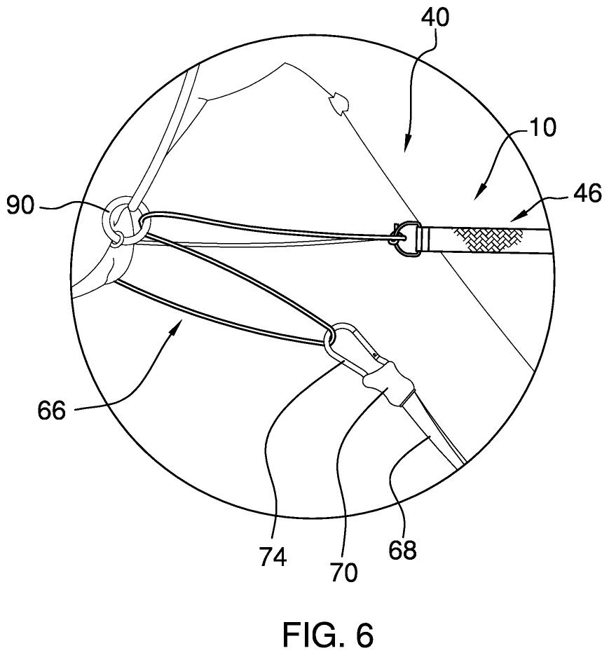

With reference now to the drawings, and in particular to FIGS. 1 through 6 thereof, a new training aid embodying the principles and concepts of an embodiment of the disclosure and generally designated by the reference numeral 10 will be described.

As best illustrated in FIGS. 1 through 6, the training aid 10 generally comprises a support assembly 12 configured to wrap around a back 80 and a belly 82 of a horse 78. The support assembly 12 comprises a saddle pad 14, a girth 24, a first support coupler 32 and a second support coupler 34. During use, the saddle pad 14 lies atop the back 80 of the horse 78, the girth 24 lies over the belly 82 of the horse 78, and the first and second support couplers 32, 34 removably attach the girth 24 to the saddle pad 14. The saddle pad 14 comprises a compressible material such as a polymer foam, fluffed cotton, or the like which distributes forces caused by tension in the support assembly 12 across the back 80 of the horse 78. In other embodiments, a saddle, a lunge roller, or the like may be used in place of the saddle pad 14. The girth 24 may also include a compressible material for distributing forces on the belly 82. The saddle pad 14 and the girth 24 preferably comprise soft materials on their exteriors such as cotton, wool, or other suitable fabrics to avoid irritation on the skin of the horse 78.

The first support coupler 32 attaches a first end 26 of the girth 24 to the saddle pad 14, and the second support coupler 34 attaching a second end 28 of the girth 24 to the saddle pad 14. Each one of the first and second support couplers 32, 34 comprises a pair of buckles 36, 38 which are adjustable to adapt to different sizes of horse. Each one of the first and second support couplers 32, 34 also comprises an elastic material such that the saddle pad 14 is resiliently movable away from the girth 24 via stretching of the first and second support couplers 32, 34. This stretching further distributes forces across the horse 78 and generally allows for greater movement of the support assembly 12 in response to movement of the horse 78 and greater comfort for the horse 78 compared to other devices.

A rein assembly 40 is attached to and extends between a first lateral portion 16 of the saddle pad 14 and a second lateral portion 18 of the saddle pad 14. The rein assembly 40 has a first rein clip 42 which removably attaches the rein assembly 40 to a first D-ring 20 of the saddle pad 14 and a second rein clip 44 which removably attaches the rein assembly 40 to a second D-ring 22 of the saddle pad 14. The first and second rein clips 42, 44 are carabiner clips but may be any suitable type of clip. Likewise, the first and second D-rings 20, 22 of the saddle pad 14 may be replaced with O-rings or other suitable attachments for the first and second rein clips 42, 44 in other embodiments. The rein assembly 40 may attach to the saddle pad 14 via any suitable fastening means. During use, the rein assembly 40 received through each one of a pair of bit rings 90 of a bit 88 worn by the horse 78, and the rein assembly 40 is slidable with respect to each bit ring 90.

The rein assembly 40 comprises a first side rein 46, a second side rein 48, and a connecting line 66 which couples and extends between the first and second side reins 46, 48. A saddle end 50 of the first side rein 46 is attached to the first lateral portion 16 of the saddle pad 14, and a saddle end 52 of the second side rein 48 is attached to the second lateral portion 18 of the saddle pad 14. Each one of the first and second side reins 46, 48 has a bit end 54, 56 opposite the saddle end 50, 52 which attach to opposite ends of the connecting line 66.

Each one of the first and second side reins 46, 48 comprises a webbing 58, 60 and a plurality of intermediate rings 62, 64. The webbing 58, 60 for each side rein extends between the saddle end 50, 52 and the bit end 54, 56, and the intermediate rings 62, 64 are spaced from each other along the webbing 58, 60 between the saddle end 50, 52 and the bit end 54, 56. The intermediate rings 62, 64 are D-rings, but may be O-rings or any other suitable fastener. The intermediate rings 62, 64 may be used to adjust a length of the rein assembly 40 between the first and second lateral portions 16, 18 of the saddle pad 14 by threading the rein assembly 40 through the D-rings of the saddle pad 14 and connecting the rein clips 42, 44 to one of the intermediate rings 62, 64.

The connecting line 66 comprises a paracord material which readily slides through the bit rings 90. The connecting line 66 may comprise any other suitable material which readily slides through the bit rings 90, such as any suitable form of rope, cord, or the like. Webbing material is typically not used for the connecting line 66, as it will have a tendency to bind against the bit rings 90 when under tension.

A tie down strap 68 is removably coupled to the rein assembly 40 and the support assembly 12. A first end 70 of the tie down strap 68 is slidably coupled to the rein assembly 40 and configured to be positioned between the pair of bit rings 90 along the rein assembly 40 during use. A second end 72 of the tie down strap 68 is coupled to the girth 24 via a girth D-ring 30 or other suitable mounting member. The tie down strap 68 includes a resiliently stretchable material which allows the horse 78 to move its head 84 to stretch the tie down strap 68. The tie down strap 68 has a first clip 74 at the first end 26 which removably couples to the rein assembly 40 and a second clip 76 at the second end 28 which removably couples to the support assembly 12. The first and second clips 74, 76 of the tie down strap 68 are carabiners but may be any suitable clip. Additionally, any other suitable removable fastener may be used to secure the tie down strap 68 to the rein assembly 40 and the support assembly 12, such as a snap connection, a hook-and-loop fastener, or the like.

In use, the training aid of 10 is placed onto the horse 78 to acclimatize the horse 78 to being bridled. The support assembly 12 is arranged around the back 80 and the belly 82 of the horse 78 as described, and the rein assembly 40 is attached to the support assembly 12 and threaded through the bit rings 90. The tie down strap 68 is attached to the rein assembly 40 and extends through a pair of front legs 84 of the horse 78 to attach to the girth 24. The horse 78 is then able to move its head 84 from side to side, because the bit rings 90 will slide along the connecting line 66 of the rein assembly 40. This allows the horse 78 to grow accustomed to being bridled without panicking due to a bridle or harness that is overly restrictive. The horse 78 is also allowed to raise its head 84 such that the tie down strap 68 stretches. The stretching of the tie down strap 68 induces a tension force which indicates to the horse 78 to lower its head 84 without being so restrictive as to cause the horse 78 to be in pain or begin to panic.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A training aid for a horse comprising:
a support assembly configured to wrap around a back and a belly of the horse, the support assembly comprising an upper member configured to lie on the back of the horse and a lower member configured to lie over the belly of the horse, wherein the upper member of the support assembly defines a saddle pad, the saddle pad comprising a compressible material;
a rein assembly attached to and extending between a first lateral portion of the upper member and a second lateral portion of the upper member, the rein assembly being configured to be received through each one of a pair of bit rings, the rein assembly being configured to be slidable with respect to each bit ring; and
a tie down strap removably coupled to the rein assembly and the support assembly, a first end of the tie down strap being slidably coupled to the rein assembly and configured to be positioned between the pair of bit rings along the rein assembly, a second end of the tie down strap being coupled to the lower member of the support assembly, wherein the tie down strap is configured to extend from the rein assembly between a pair of front legs of the horse to the belly during normal use, the tie down strap including a resiliently stretchable material.

2. The aid of claim 1, wherein the rein assembly comprises:
a first side rein and a second side rein, a saddle end of the first side rein being attached to the first lateral portion of the upper member of the support assembly, a saddle end of the second side rein being attached to the second lateral portion of the upper member, each one of the first and second side reins having a bit end opposite the saddle end, each one of the first and second side reins comprising a webbing which extends between the saddle end and the bit end; and
a connecting line coupled to and extending between the bit ends of the first and second side reins, the connecting line being configured to be slidable through the pair of bit rings.

3. The aid of claim 2, wherein the connecting line comprises a paracord material.

4. The aid of claim 2, wherein each one of the first and second side reins further comprises a plurality of intermediate rings which are coupled to and spaced from each other along the webbing between the saddle end and the bit end.

5. The aid of claim 1, wherein the tie down strap has a first clip at the first end which removably couples to the rein assembly.

6. The aid of claim 1, wherein the tie down strap has a second clip at the second end which removably couples to the support assembly.

7. (canceled)

8. The aid of claim 1, wherein the support assembly further comprises a first support coupler and a second support coupler, the first support coupler removably attaching a first end of the lower member to the upper member, the second support coupler removably attaching a second end of the lower member to the upper member.

9. The aid of claim 8, wherein each one of the first and second support couplers comprises a buckle.

10. The aid of claim 8, wherein each one of the first and second support couplers comprising an elastic material such that the saddle pad is resiliently movable away from the girth via stretching of the first and second support couplers.

11. A training aid for a horse comprising:
a support assembly configured to wrap around a back and a belly of the horse, the support assembly comprising:
a saddle pad configured for positioning on the back of the horse, the saddle pad comprising a compressible material;
a girth configured for positioning over the belly of the horse; and
a first support coupler and a second support coupler, the first support coupler attaching a first end of the girth to the saddle pad, the second support coupler attaching a second end of the girth to the saddle pad, each one of the first and second support couplers comprising a buckle, each one of the first and second support couplers comprising an elastic material such that the saddle pad is resiliently movable away from the girth via stretching of the first and second support couplers;
a rein assembly attached to and extending between a first lateral portion of the saddle pad and a second lateral portion of the saddle pad, the rein assembly being configured to be received through each one of a pair of bit rings, the rein assembly being configured to be slidable with respect to each bit ring, the rein assembly comprising:
a first side rein and a second side rein, a saddle end of the first side rein being attached to the first lateral portion of the saddle pad, a saddle end of the second side rein being attached to the second lateral portion of the saddle pad, each one of the first and second side reins having a bit end opposite the saddle end, each one of the first and second side reins comprising a webbing and a plurality of intermediate rings, the webbing extending between the saddle end and the bit end, the plurality of intermediate rings being coupled to and spaced from each other along the webbing between the saddle end and the bit end; and
a connecting line coupled to and extending between the bit ends of the first and second side reins, the connecting line being configured to be slidable through the pair of bit rings, the connecting line comprising a paracord material;
a tie down strap removably coupled to the rein assembly and the support assembly, a first end of the tie down strap being slidably coupled to the rein assembly and configured to be positioned between the pair of bit rings along the rein assembly, a second end of the tie down strap being coupled to the girth, the tie down strap including a resiliently stretchable material, the tie down strap having a first clip at the first end which removably couples to the rein assembly, the tie down strap having a second clip at the second end which removably couples to the support assembly.
